(19) United States
(12) Patent Application Publication
(10) Pub. No.: US 2012/0164425 A1
(43) Pub. Date: Jun. 28, 2012

(54) FOAM SHEET BASED ON STYRENE POLYMER-POLYOLEFIN MIXTURES

(75) Inventors: Holger Ruckdäschel, St. Martin (DE); Jens Aßmann, Mannheim (DE); Carsten Schips, Speyer (DE); Klaus Hahn, Kirchheim (DE); Georg Gräßel, Ludwigshafen (DE); Jürgen Lambert, Gommersheim (DE); Christof Zylla, Limburgerhof (DE); Peter Merkel, Zellertal (DE); Geert Janssens, Nieuwkerken-Waas (BE)

(73) Assignee: BASF SE, Ludwigshafen (DE)

(21) Appl. No.: 13/335,520

(22) Filed: Dec. 22, 2011

Related U.S. Application Data
(60) Provisional application No. 61/427,488, filed on Dec. 28, 2010.

(51) Int. Cl. B32B 3/26; B29C 47/78; B29C 47/00

(52) U.S. Cl. 428/220; 264/41

(57) ABSTRACT

A thermoplastic extruded foam sheet having a thickness in the range from 15 mm to 200 mm and cells having an average cell size in the range from 20 to 2000 μm, wherein the cell membranes have a fibrous structure with fiber diameters below 1500 nm is useful for example as insulating material, especially in the building construction industry.

### CROSS-REFERENCE TO RELATED APPLICATIONS

This application claims the benefit of U.S. Provisional Application Ser. No. 61/427,488 filed Dec. 28, 2010, the entire contents of which are incorporated herein by reference in its entirety.

### FIELD OF THE INVENTION

This invention relates to a thermoplastic extruded foam sheet based on styrene polymers, polyolefins and solubilizers, a process for production thereof and the use of the sheet, for example as insulating material in the building construction industry.

### BACKGROUND

Particle foams based on polyolefin-styrene polymer mixtures are known for example from WO-A 2008/125250. There are significant differences in the ways particle foams and extruded foams are produced. To produce particle foams, granules laden with blowing agent are heated from temperatures below the softening point of the product system by injection of energy (generally steam) and expand (=undergo prefoaming). The prefoaming operation typically takes on the order of minutes. Thereafter, the prefoamed granules are conditioned and finally welded together in a mold by the renewed injection of energy (generally steam) to form moldings or blocks. The structure formation of multi-phase systems accordingly always starts at low temperatures which, in the specific case, are below the melting point of polyolefins.

In contrast, the production of extruded foams involves the material first being completely melted or plastified and impregnated with blowing agents at elevated pressures. Following possible cooling of the melt, foam formation is generally induced through rapid reduction in pressure (for example through emergence of the laden melt from a die/nozzle into the surrounding atmosphere). Foaming and development of morphology takes place within seconds or fractions of seconds. The structure formation of multi-phase systems also begins at temperatures which, in the specific case, are above the melting point of polyolefins.

The different processing operations involved in particle foams and extruded foams and also the different requirements in respect of further processing therefore do not permit any inferences about the suitability of known particle foam systems for use as extruded foams.

U.S. Pat. No. 5,225,451 describes an extruded foam comprising polyethylene as continuous phase, a styrene-butadiene rubber and from 1% to 15% by weight of polystyrene.

Japanese documents JP-A 2008-173923, JP-A 2000-204185, JP-A 2004-238413, JP-A 2003-183438, JP-A 2000-212356 describe extruded sheets of foam based on polystyrene-polyethylene blends incorporating a solubilizer.

JP-A 2001-310968 describes extruded foam sheets comprising from 70% to 40% by weight of polyethylene, from 30% to 60% by weight of polystyrene and from 2% to 15% by weight of a partially hydrogenated styrene-butadiene block copolymer.

JP-A 2008-274072 discloses an extruded foam sheet comprising polystyrene, polyethylene, polypropylene and a styrene rubber system comprising block copolymers having polystyrene blocks at both ends and a polybutadiene or polyisoprene block therebetween. Chemical blowing agents are preferred.

Although the systems described do already provide good results, there remains huge scope for improvements, for example with regard to resistance to solvents, elasticity, damping behavior and low imbibition of water.

### BRIEF SUMMARY

It is an object of the present invention to develop further extruded foam sheets having an improved profile of properties, particularly in respect of the properties mentioned.

We have found that this object is achieved by using styrene polymers, polyolefins and certain solubilizers to obtain extruded foam sheets having a fibrous structure for their cell membranes and having an advantageous spectrum of properties.

Essential requirements in the production of extruded foams having such a structure and hence advantageous properties are: (i) establishing the desired properties during the foaming operation, which is on the order of seconds or fractions of seconds, (ii) ensuring a sufficiently high closed-cell content of above 80%, since open cells are generally favored by the presence of additional phases in polystyrene foams.

The present invention accordingly provides a thermoplastic extruded foam sheet having a thickness in the range from 15 mm to 200 mm and cells having an average cell size in the range from 20 to 2000 μm, wherein the cell membranes have a fibrous structure with fiber diameters below 1500 nm. Preferably, the foam is formed of a polymer matrix comprising at least two incompatible thermoplastic polymers and at least one polymeric compatibilizer and forming a continuous phase and a disperse phase and wherein preferably the continuous phase comprises one or more styrene polymers and the disperse phase comprises two or more polyolefins and preferably in each case consists thereof.

More particularly, the foam is formed of
c) from 45% to 97.8% by weight of one or more styrene polymers,
B1) from 1% to 25% by weight of one or more polyolefins having a melting point in the range from 105 to 140° C.,
B2) from 1% to 25% by weight of one or more polyolefins having a melting point below 105° C.,
C1) from 0.1% to 20% by weight of at least one butadiene and/or isoprene-containing styrene block copolymer,
C2) from 0.1% to 10% by weight of at least one ethylene-, butylene- and/or propylene-containing styrene block copolymer.

The present invention further provides a process for producing the extruded foam sheet according to the present invention, comprising
a) heating a mixture of at least two incompatible thermoplastic polymers and one or more polymeric compatibilizers to form a polymer melt having a continuous and disperse phase,
b) impregnating the polymer melt with from 1 to 12 parts by weight (based on the polymers in the polymer melt (P), which counts as 100 parts by weight of a physical blowing agent, and
c) extruding the foamable polymer melt into a region of lower pressure to form a sheet of foam by expansion preferably in the range from 120 to 170° C. for the temperature of the die lip of the slot die, in the range from 50 to 160° C. for the temperature of the polymer melt and above 50 bar for the pressure upstream of the die.

The present invention similarly provides for the use of the foam sheets according to the present invention as insulating material, structural foam, core material for composite applications, material for energy absorption and/or as material for packaging applications.

### BRIEF DESCRIPTION OF THE DRAWINGS

FIG. 1 shows a scanning electron micrograph (SEM) of a foam strut with cell wall.

### DETAILED DESCRIPTION OF THE PREFERRED EMBODIMENTS

The foam sheet according to the present invention generally exhibits progressive behavior in compression, a good damping behavior and a good ductility. It has good insulation properties, good solvent resistance and good heat resistance. It thereby combines three important properties in one material of construction and thus enables the universal use of this material of construction in the most disparate applications which hitherto necessitated the use of various materials of construction which were specifically adapted to the particular use. The foam sheet according to the present invention is obtainable without the use of blowing agents that are problematical from environmental aspects or in relation to fire protection regulations. In addition, despite its low density compared with prior art extruded foams, the foam sheet according to the present invention offers good insulation and mechanical properties combined with high solvent and heat resistance.

The foam sheet according to the present invention preferably has a cuboid-shaped base structure wherein thickness by definition designates the shortest edge (height). The upper limit of thickness is preferably 200 mm. The lower limit of thickness is preferably 15 mm, more preferably 20 mm and even more preferably 25 mm.

The foam sheet according to the present invention preferably includes cells having an average cell size in the range from 20 to 1000 μm and more particularly in the range from 50 to 500 μm, average cell size being defined as per ASTM D3576-04.

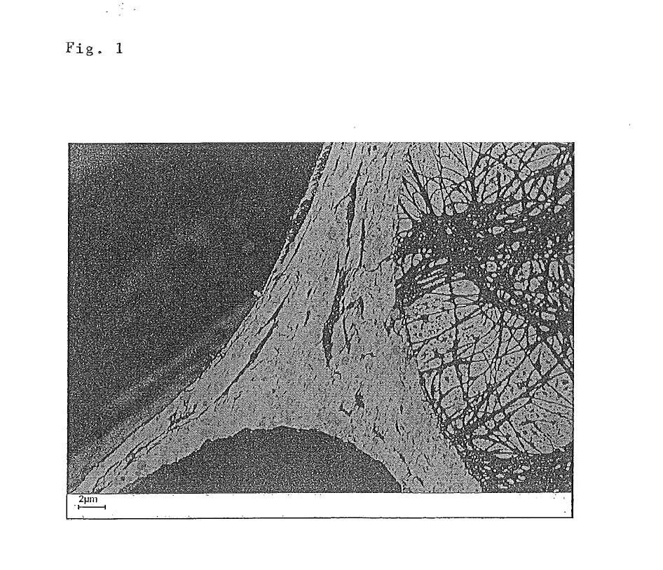

The cell walls have a fibrous structure, as reproduced in FIG. 1 by way of example. FIG. 1 shows a scanning electron micrograph (SEM) of a foam strut with cell wall. An ESB (energy-selective-backscattered-electron) detector was used (high voltage 1.00 kV). The light regions are polystyrene and the dark regions are PE flexible phase with distinctly visible fibrillar structure. The average fiber diameter is below 1500 nm, preferably in the range from 10 to 1000 nm, more preferably in the range from 10 to 500 nm and even more preferably in the range from 20 to 250 nm. The length of the fibrous structure is at least 5 times the average diameter, preferably at least 10 times the average diameter and more preferably at least 20 times the average diameter. The average fiber diameter is determined according to the present invention by analyzing micrographs of the foam structure (scanning electron microscopy). At least three micrographs of the cell walls are analyzed at a time. The structures with a fibrous appearance are analyzed in respect of diameter at four or more different positions and the number average is formed.

The foam sheet according to the present invention is preferably closed-cell, which is to be understood as meaning according to the present invention that the cells when measured to DIN ISO 4590 are at least 80% and more particularly from 90 to 100% closed.

The density of the foam sheet according to the present invention is preferably in the range from 20 to 150 g/l, more preferably in the range from 25 to 120 g/l and even more preferably in the range from 30 to 80 g/l. The cell count is preferably in the range from 0.5 to 30 cells per mm and more particularly in the range from 1 to 20 cells per mm.

In general, the extruded foam according to the present invention is formed of a polymer matrix comprising a continuous phase, rich in styrene polymer, and a discontinuous phase, rich in polyolefin.

“Formed of a polymer matrix” is to be understood as meaning according to the present invention that the polymer matrix is the structure-conferring element. However, in addition to polymer matrix and blowing agent, the foam may comprise further added substances. All particulars in % by weight for individual polymers relate, unless otherwise stated, to the entire polymer matrix (=100% by weight) without additives.

The polymer matrix preferably comprises (and consists more particularly of)
A) from 45% to 97.8% by weight of one or more styrene polymers,
B1) from 1% to 25% by weight of one or more polyolefins having a melting point in the range from 105 to 140° C.,
B2) from 1% to 25% by weight of one or more polyolefins having a melting point below 105° C.,
C1) from 0.1% to 25% by weight of at least one butadiene- and/or isoprene-containing styrene block copolymer,
C2) from 0.1% to 10% by weight of at least one ethylene-, butylene- and/or propylene-containing styrene block copolymer.

The polymer matrix preferably comprises from 55.0% to 89.9% by weight of one or more styrene polymers.

According to the present invention, the term styrene polymer comprises polymers based on styrene and further comonomers, for example alpha-methylstyrene, acrylonitrile, methyl methacrylate; the minimum styrene content of the styrene polymer is 90% by weight.

Preference for use as styrene polymers is given to crystal clear general purpose polystyrene (GPPS), anionically polymerized polystyrene, styrene-α-methylstyrene copolymers, styrene-acrylonitrile copolymers (SAN), acrylonitrile-alpha-methylstyrene copolymers (AMSAN) or mixtures thereof with polyphenylene ether (PPE). It is also possible to use impact-modified versions thereof, for example high impact polystyrene (HIPS), anionically polymerized impact polystyrene (A-IPS), acrylonitrile-butadiene-styrene polymers (ABS), methylacrylate-butadiene-styrene (MBS), acrylonitrile-styrene-acrylic ester (ASA), methyl methacrylate-acrylonitrile-butadiene-styrene (MABS) polymers or mixtures thereof with polyphenylene ether (PPE).

It is also possible to admix polymer recyclates of the thermoplastic polymers mentioned, more particularly styrene polymers and expandable styrene polymers (EPS) in amounts which do not significantly worsen properties thereof, generally in amounts of not more than 50% by weight and more particularly in amounts of 1% to 20% by weight (based on component A).

Polystyrene is preferred. Particular preference is given to standard polystyrene types having weight average molecular weights in the range from 120 000 to 300 000 g/mol and an MVR melt volume rate (200° C./5 Kg) to ISO 113 in the range from 1 to 10 cm³/10 min, for example PS 158 K, 168 N or 148 G from Styrolution GmbH.

By way of further constituents, the polymer matrix generally comprises a polyolefin component B consisting of one or more thermoplastic polyolefins incompatible with component A. Preferably, the polyolefin component B consists of
B1) from 1% to 25% by weight (based on the polymer matrix) of one or more polyolefins having a melting point in the range from 105 to 140° C.,
B2) from 1% to 25% by weight (based on the polymer matrix) of one or more polyolefins having a melting point below 105° C.

Polymer B1) is preferably a homo- or copolymer of ethene, more particularly in combination with propene. Commercially available polyethylenes such as PE-LD, PE-LLD, PE-HD are used as homopolymers. Useful copolymers include inter alia the following systems: copolymers of ethene and propene (for example Moplen® RP220 and Moplen® RP320 from Basell), copolymers of ethene and vinyl acetate (EVA), copolymers of ethene and acrylates (EA, e.g., Surlyn® types 1901 and 2601 from DuPont) or copolymers of ethene, butene and acrylates (EBA, e.g., Lucofin® 1400 HN, 1400 HM from Lucobit AG). The MVI melt volume index (190° C./2.6 kg) of polyethylenes is typically in the range from 0.5 to 40 g/10 min, the density is in the range from 0.86 to 0.97 g/cm³ and preferably in the range from 0.91 to 0.95 g/cm³. In addition, blends with polyisobutylene (OIB) (e.g., Oppanol® B150 from BASF SE) can be used.

Polymer B2) is preferably a copolymer of ethene, for example ethene with octene (EOC, e.g., Engage®, Dow).

The proportion of the polymer matrix which is attributable to component B1) is preferably in the range from 2% to 25% by weight and more preferably in the range from 5% to 20% by weight. In a preferred embodiment, the proportion of component B2) is in the range from 2% to 25% by weight and more preferably in the range from 5% to 20% by weight.

The desired morphology is specifically established by typically using at least two different compatibilizers (component C) in amounts of all together 0.2% to 35% by weight and preferably 0.2% to 5% by weight, based on the polymer matrix.

The compatibilizers lead to improved adherence between the polyolefin-rich phase and the polystyrene-rich phase and distinctly improve the elasticity of the foam even in small amounts over conventional EPS foams.

Component C) preferably consists of
C1) from 0.1% to 25% by weight (based on the polymer matrix) of at least one butadiene- and/or styrene-isoprene-containing styrene block copolymer and
C2) from 0.1% to 10% by weight (based on the polymer matrix) of at least one ethylene-, butylene- and/or propylene-containing styrene block copolymer.

According to the present invention, butadiene-, isoprene-, ethylene-, butylene- or propylene-containing styrene block copolymer is to be understood as referring to a polymer which is obtainable by polymerization of these monomers and which then includes the corresponding saturated or partially unsaturated structures.

Component (C1) is suitably for example an unhydrogenated or partially hydrogenated styrene-butadiene or styrene-isoprene block copolymer. Total styrene content is preferably in the range from 40% to 80% by weight and more preferably in the range from 50% to 70% by weight (based on (C1)).

Suitable styrene-butadiene block copolymers consisting of at least two polystyrene blocks S and at least one styrene-butadiene copolymer block S/B are for example star-branched block copolymers as described in EP-A 0 654 488.

The block copolymers used include at least one hard block having a glass transition temperature of at least 80° C. and at least one soft block having a glass transition temperature of at most −20° C. The glass transition temperatures of the different blocks are determined to ASTM D 5026-01 at a frequency of 1 Hz as maximum of the loss modulus.

It is further possible to use block copolymers having at least two hard blocks S₁ and S₂ of vinylaromatic monomers with at least one in-between random soft block B/S of vinylaromatic monomers and diene, wherein the proportion of hard blocks is above 40% by weight, based on the entire block copolymer, and the 1,2-vinyl content in the B/S soft block is below 20%, which are described in WO 00/58380.

Suitable compatibilizers (C1) further include linear styrene-butadiene block copolymers of the general structure —S—(S/B)—S with one or more blocks (S/B)_{random} between the two S blocks and having a random styrene-butadiene distribution. Such block copolymers are obtainable by anionic polymerization in an apolar solvent in the presence of a polar cosolvent or a potassium salt, as described in WO 95/35335 and WO 97/40079 for example.

By vinyl content is meant the relative proportion of 1,2-linkages of the diene units, based on the sum total of the 1,2-, 1,4-cis and 1,4-trans linkages. The 1,2-vinyl content of the styrene-butadiene copolymer block (S/B) is preferably below 20%, more particularly in the range from 10% to 18% and more preferably in the range from 12 to 16%.

By way of compatibilizer (C1) it is preferable to use styrene-butadiene-styrene (SBS) triblock copolymers having a butadiene content in the range from 20% to 60% by weight and preferably 30% to 50% by weight, which can each be hydrogenated or nonhydrogenated. These are commercially available for example under the designation Styroflex® 2G66, Styrlux® 3G55, Styroclear® GH62, Kraton® D 1101, Kraton® G 1650, Kraton® D 1155, Tuftec® H1043 or Europren® SOL 6414. Concerned here are SBS block copolymers having sharp transitions between B- and S-blocks.

Improved compatibility can additionally be achieved by partially hydrogenating the butadiene blocks, e.g., Kraton® G types.

Suitable for use as component (C2) are styrene-ethylene-butylene block copolymers, for example linear triblock copolymers based on styrene and ethylene/butylene blocks (S-E/B—S), as available under the designation Kraton® G1654 from Kraton Polymers GmbH, Eschborn, Germany. Also suitable are styrene-ethylene/propylene-styrene block copolymers (SEPS), as marketed for example by Kuraray Co. Ltd., Tokyo, Japan under the designation Septon® 2063 for example.

The following materials are particularly preferred as components A) to C) of the polymer matrix:

Polystyrene is particularly preferred as component A).

Polyethylene is particularly preferred as component B1).

An ethylene-octene copolymer is particularly preferred as component B2).

A styrene-butadiene block copolymer is particularly preferred as component C1).

A styrene-ethylene/butylene block copolymer is particularly preferred as component C2).

It is particularly preferable for the polymer matrix to consist of the particularly preferred components.

It is preferable for the polymer matrix to comprise the components mentioned in the following proportions:

from 75% to 95% by weight of component A);

from 2% to 14% by weight of component B1);

from 2% to 14% by weight of component B2);

from 0.4% to 6% by weight of component C1) and

from 0.4% to 2.5% by weight of component C2).

In a preferred embodiment, the sum total of components B1) and B2) is >15% by weight and the proportion of component B1) shall be greater than the proportion of component B2).

The extruded foam sheet according to the present invention, in addition to the polymer matrix, comprises a blowing agent component (T).

The blowing agent component (T) comprises (and preferably consists of)
(b1) 100-15% by weight, preferably 85-15% by weight and more preferably 75-15% by weight (based on (T)) of CO₂,
(b2) 0-85% by weight, preferably 15-75% by weight and more preferably 25-75% by weight (based on T) of one or more, preferably one or two and more particularly one co-blowing agent from the group of C₁-C₄ alcohols and C₁-C₄ carbonyl compounds, preferably C₂-C₄ carbonyl compounds and more particularly C₃-C₄ ketones and formates, and also
(b3) from 0% to 10% by weight, preferably from 0% to 5% by weight and more preferably from 0% to 2% by weight of water (all based on T),
(b4) from 0% to 10% by weight and preferably from 0% to 5% by weight of nitrogen (based on T).

Preference for use as blowing agent component (T) is given to mixtures of CO2 and one or two co-blowing agents. Binary mixtures are particularly preferred.

Preferred alcohols are methanol, ethanol, 1-propanol, 2-propanol, 1-butanol, 2-butanol, 2-methylpropanol and tert-butanol. Ethanol is particularly preferred.

C₁-C₄ Carbonyl compounds are ketones, aldehydes, carboxylic esters and also carboxamides having 1 to 4 carbon atoms.

Suitable ketones are acetone and methyl ethyl ketone and preferred formates are methyl formate, ethyl formate, n-propyl formate and i-propyl formate. Acetone is preferred.

The co-blowing agents b2) and the carbon dioxide b1) may comprise water b3). Water in the blowing agent component T ends up there particularly through the use of technical grade alcohols and ketones. A preferred embodiment utilizes a blowing agent component T having a water content b3) of not more than 10% by weight, preferably not more than 5% by weight, more preferably not more than 4% by weight and even more preferably not more than 2% by weight (all based on T).

In a further preferred embodiment, the blowing agent component is substantially free of water. Particular preference is given to mixtures of carbon dioxide and ethanol, carbon dioxide and acetone, carbon dioxide and methyl formate and also carbon dioxide and mixtures of ethanol and acetone in the abovementioned mixing ratios.

The blowing agent component T is added to the polymer melt in a proportion of altogether 1 to 12 parts by mass preferably 1 to 8 and even more preferably 1.5 to 7 parts by mass (all based on the polymer matrix P, which counts as 100 parts by mass).

A suitable composition of blowing agent component T comprises from 15% to 100% by weight of component b1) and from 0% to 85% by weight of component b2). Preferably, the proportion of component b1) based on P is less than 6 parts by mass and the proportion of component b2) based on P is less than 2 parts by mass and the overall proportion of components b1) and b2) based on P is less than 8 parts by mass. It is particularly preferable for the proportion of component b1) based on P to be less than 4.5 parts by mass and for the proportion of component b2) based on P to be less than 4 parts by mass.

The blowing agent contents based on the polymer matrix concern the initial content as are obtainable in the production of the extruded foam sheets. A person skilled in the art knows that these values decrease as blowing agent diffuses out of the final foam sheet.

In one embodiment, the polymer matrix P comprises additives, i.e., auxiliary and/or added substances. Suitable auxiliary and added substances are known to a person skilled in the art.

In a preferred embodiment, a nucleating agent is added to the polymer matrix P at least. Useful nucleating agents include finely divided inorganic solids such as talc, metal oxides, silicates or polyethylene waxes in amounts of generally 0.1 to 10 parts by mass, preferably 0.1 to 3 parts by mass and more preferably 1 to 1.5 parts by mass, based on 100 parts by mass of P. The average particle diameter of the nucleating agent is generally in the range from 0.01 to 100 μm and preferably in the range from 1 to 60 μm. Talc is a particularly preferred nucleating agent from Luzenac Pharma for example. The nucleating agent can be added according to methods known to a person skilled in the art.

If desired, one or more additives such as nucleators, fillers (for example mineral fillers such as glass fibers), plasticizers, flame retardants, IR absorbers such as carbon black or graphite, aluminum powder and titanium dioxide, soluble and insoluble dyes and also pigments can be added. Graphite and carbon black are preferred additives.

It is particularly preferable to add graphite in amounts of generally 0.05 to 25 parts by mass and even more preferably in amounts of 2 to 8 parts by mass, based on 100 parts by mass of P. Suitable particle sizes for the graphite used are in the range from 1 to 50 μm and preferably in the range from 2 to 10 μm.

Owing to the fire protection regulations in the building construction industry and other industries, it is preferable to add one or more flame retardants. Suitable flame retardants are for example bromine and/or phosphorus compounds such as tetrabromobisphenol A, brominated polystyrene oligomers, brominated styrene-butadiene copolymers, tetrabromobisphenol A diallyl ether, expandable graphite, red phosphorus, triphenyl phosphate and 9,10-dihydro-9-oxa-10-phosphaphenanthrene 10-oxide. A further suitable flame retardant is for example hexabromocyclododecane (HBCD), more particularly the technical grade products which comprise essentially the α-, β- and γ-isomer and preferably an addition of Dicumyl (2,3-dimethyl-2,3-diphenylbutane) as synergist.

It is particularly the addition of graphite, carbon black, aluminum powder or of an IR dye (e.g., indoaniline dyes, oxonol dyes or anthraquinone dyes) which is preferred for thermal insulation.

Dyes and pigments are generally added in amounts ranging from 0.01 to 30 parts by mass and preferably ranging from 1 to 5 parts by mass, based on 100 parts by mass of (P). To ensure homogeneous and microdisperse distribution of the pigments in the polymer melt it can be advantageous in the case of polar pigments in particular to add a dispersing assistant, for example organosilanes, epoxy-containing polymers or maleic anhydride-grafted styrene polymers.

The total amount of additives is generally in the range from 0 to 30 parts by mass and preferably in the range from 0 to 20 parts by mass based on the polymers (P) which have 100 parts by mass.

In a preferred embodiment, the total amount of additives is in the range from 0.5 to 30 parts by mass and more preferably in the range from 0.5 to 20 parts by mass based on the polymers (P) which have 100 parts by mass.

In a further embodiment, the foam sheet according to the present invention comprises no additives.

The extruded foam sheet according to the invention is obtainable by
(a) heating a polymer component P formed of a mixture of at least two incompatible thermoplastic polymers and one or more polymeric compatibilizers, preferably a mixture of one or more styrene polymers, one or more polyolefins and one or more polymeric compatibilizers, more preferably:
   A) from 45% to 97.8% by weight of one or more styrene polymers,
   B1) from 1% to 25% by weight of one or more polyolefins having a melting point in the range from 105 to 140° C.,
   B2) from 1% to 25% by weight of one or more polyolefins having a melting point below 105° C.,
   C1) from 0.1% to 20% by weight of at least one butadiene- and/or isoprene-containing styrene block copolymer,
   C2) from 0.1% to 10% by weight of at least one ethylene-, butylene- and/or propylene-containing styrene block copolymer,
(b) introducing from 1 to 12 parts by mass (based on 100 parts by mass of P) of a blowing agent component T comprising
   b1) from 15% to 100% by weight (based on T) of carbon dioxide and
   b2) from 0% to 85% by weight (based on T) of one or more co-blowing agents selected from the group consisting of C₁-C₄ alcohols and C₁-C₄ carbonyl compounds
   into the polymer melt to form a foamable melt,
(c) extruding the foamable melt into a region of lower pressure to form the extruded foam by expansion,
(d) optionally adding additives to the polymer component P or in at least one of steps a), b) and/or c).

Step (a) of the process comprises heating the polymer component P in order that a polymer melt may be obtained. To form a polymer melt is to be understood in the context of the present invention as meaning a plastification of the polymer component P in the wider sense, i.e., the conversion of the solid constituents of polymer component P into a moldable or flowable state. This requires the polymer component P to be heated to a temperature above the melting or glass transition temperature. Suitable temperatures are generally at least 140° C., preferably in the range from 150 to 260° C. and more preferably in the range from 160 to 220° C.

Heating the polymer component P (step (a) of the process according to the present invention) can be effected using any desired appliances known in the pertinent field, such as an extruder or a mixer (a kneader for example). It is preferable to use melting extruders (primary extruders). Step (a) of the process according to the present invention can be carried out continuously or batchwise, in which case a continuous operation is preferred.

Step (b) of the process according to the present invention comprises introducing the above-described blowing agent component T into the polymer melt produced in step (a), to form a foamable melt.

The blowing agent component T can be introduced into a molten polymer component P by any method known to a person skilled in the art. Extruders or mixers (kneaders for example) are suitable for example. In a preferred embodiment, the blowing agent is mixed with the molten polymer component P under elevated pressure. The pressure has to be sufficient to essentially prevent any foaming of the molten polymeric material and ensure a homogeneous distribution of the blowing agent component T in the molten polymer component P. Suitable pressures are 50 to 500 bar (absolute), preferably 100 to 300 bar (absolute) and more preferably 150 to 250 bar (absolute). The temperature in step (b) of the process according to the present invention has to have been chosen such that the polymeric material is in a molten state. This requires the polymer component P to be heated to a temperature above the melting or glass transition temperature. Suitable temperatures are generally at least 140° C., preferably in the range from 150 to 260° C. and more preferably in the range from 160 to 220° C.

The addition of the blowing agent can take place in the melting extruder (primary extruder) or in a subsequent step.

In a preferred embodiment, the foamable polymer melt is produced in XPS extruders known to a person skilled in the art, for example via a tandem setup of melting extruder (primary extruder) and cooling extruder (secondary extruder). The process can be carried out continuously and batchwise, in which case the polymer component P is melted in the primary extruder (step (a)) and adding the blowing agent (step (b)) to form a foamable melt likewise takes place in the primary extruder.

Thereafter, the foamable melt comprising blowing agent is cooled in the secondary extruder to a suitable foaming temperature in the range from 50 to 160° C. and preferably to a temperature in the range from 80 to 140° C.

In one embodiment, additives, i.e., auxiliary and/or added substances, are added to the polymer component P before performing the process and/or in at least one of steps a), b) and/or c). Suitable auxiliary and added substances are those described above.

Step (c) of the process according to the present invention comprises expanding the foamable melt in order that an extruded foam may be obtained.

For this, the melt is fed through a suitable device, for example a die plate. The die plate is heated at least to the temperature of the polymer melt comprising blowing agent. The temperature of the die plate is preferably in the range from 50 to 180° C. The temperature of the die plate is more preferably in the range from 120 to 170° C.

The polymer melt comprising blowing agent is transferred through the die plate into a region in which there is a lower pressure than in the region in which the foamable melt is maintained before extrusion through the die plate. The lower pressure can be superatmospheric or subatmospheric. Extrusion into a region of atmospheric pressure is preferred.

Step (c) is likewise carried out at a temperature at which the polymeric material to be foamed is present in the molten state, generally at temperatures in the range from 50 to 160° C., preferably in the range from 80 to 140° C. and more preferably in the range from 110 to 140° C. As a result of the polymer melt comprising blowing agent being transferred in step (c) into a region in which there is a lower pressure, the blowing agent is converted into the gaseous state. As a result of the large increase in volume, the polymer melt expands and foams up.

One version of the process according to the present invention initially produces a masterbatch comprising components A, B, C and optionally auxiliary and added substances which is admixed with further styrene polymer before or during step a) of the process.

The geometry of the cross section of the extruded foam sheet obtainable by the process according to the present invention is essentially determined by the choice of die plate and optionally by suitable downstream equipment, such as sheet calibrators, roller-conveyor takeoffs or belt takeoffs, and is freely choosable.

The extruded foam sheets obtainable by the process according to the present invention preferably have a right-angled cross section. The thickness of the extruded foams is determined by the height of the die plate slot. The width of the extruded foams is determined by the width of the die plate slot. The length of the extruded foam parts is determined in a downstream operation via processes familiar to a person skilled in the art such as adhering, welding, sawing and cutting. Particular preference is given to extruded foam sheets having a geometry where the thickness (height) dimension is small in comparison with the width dimension and the length dimension of the molding.

The present invention also provides for the use of the extruded foam sheets according to the present invention as insulating material particularly in the building construction industry, below and above ground, e.g., for foundations, walls, floors and roofs. Preference is likewise given to the use as structural foam, more particularly for lightweight construction applications and as core material for composite applications.

The present invention further provides for the use of the material for energy absorption, for example in the automotive industry for automotive applications, and in the packaging industry for packaging applications, for example for electronic goods or for food items.

The invention is more particularly elucidated by the examples which follow without being restricted thereto.

### EXAMPLES

General Method of Operation

Inventive foam sheets were produced on a tandem extrusion rig. The polymers used were continuously fed to a melting extruder together with talc. Total polymer throughput was 12 kg/h. The blowing agents (CO₂, ethanol) were continuously injected through an injection aperture in the melting extruder. The melt comprising blowing agent was cooled down in a downstream cooling extruder and extruded through a slot die (width 25 mm, height 0.8 mm). The foaming melt was drawn off via a roller conveyor, without calibration. The extruded cross sections had a height of about 15 mm and a width of about 80 mm for a typical density of 45 g/l.

Polystyrene 158K (Styrolution GmbH) was used as reference polymer for producing the foam sheet, and was generally processed into densities of about 45 g/l on the tandem extrusion rig. The density range which was technically possible extended from 25 to 150 g/l.

Three different ways were chosen to produce the inventive foam sheet (composition of materials and masterbatch see tables 1 and 2):

V1) adding to polystyrene a devolatilized, previously pentane-containing masterbatch,

V2) processing various masterbatches with and without addition of further PS,

V3) producing the blends on the extruder in one step.

This gave closed-cell sheets of foam with densities of 25-150 g/l, which had a smooth shiny skin. In general, materials having a density of 40 to 45 g/l were produced.

Incorrect choice of process parameters and/or systems without block copolymers/compatibilizers result in an increased open-cell content of systems, which is listed under V4. They include, inter alia, the correct choice of melt and die temperatures at extrusion, the compatibilization of polyolefins B) through sufficiently high proportions of C), and a sufficiently high die pressure above the saturation pressure of the blowing agents (typically >50 bar).

Test specimens were then cut out of the foam sheets obtained in tests with masterbatch No. 2 and used to determine the elastic modulus to ISO 844 and also the progressive damping behavior via ISO 3386-1 at 10% and 50% compressive stress. Solvent resistance was determined at 20° C. with purified solvents of the puriss grade by fully immersing test specimens measuring 50 by 50 mm in the solvent and completely wetting the foam sample with the solvent. Flexural properties were determined qualitatively because of the slightly different foam geometries. The foam extrudate with skin was subjected to a three-point bending test and the maximum bend to failure was assessed on a comparative basis. The results of the tests are shown in tables which follow.

Materials Used:

Component A
A) polystyrene having an MVI melt viscosity index (200° C./5 kg) of 2.9 cm³/10 min (PS 158K from Styrolution GmbH, Mw=280 000 g/mol, viscosity number VN 98 ml/g)

Component B:
B1) LLD polyethylene (LL6201 XV, Exxon Mobile, density 0.926 g/l, MVI=50 g/10 min, melting point 123° C.)
B2) ethylene-octene copolymer (Engage® 8402 from Dow, density 0.902 g/l, MVI=30 g/10 min, melting point 94° C.)

Component C:
C1) Styroflex® 2G66, thermoplastically elastic styrene-butadiene block copolymer (S-TPE) from Styrolution GmbH
C2) Kraton G 1654, styrene-ethylene-butylene block copolymer from Kraton Polymers LLC

Component D:
D1) talc (Talkum IT Extra)

### V1) Adding to Polystyrene a Devolatilized, Previously Pentane-Containing Masterbatch

In process variant V1, a pentane-containing masterbatch was initially devolatilized and subsequently foamed up on the tandem foam extrusion rig with and without addition of PS. The composition of the material is reported in table 1. The composition is reported in parts by weight such that all the polymers sum to 100 parts by weight, and the blowing agents and the nucleating agent (component D1) are additive thereto. In all cases, 35 parts by weight of CO₂ and 2.5 parts by weight of ethanol were used for the foam processing.

TABLE 1
composition of devolatilized masterbatch No. 1

| | | Masterbatch No. |
|---|---|---|
| | | 1 |
| Component A1) | (parts by weight) | 77.0 |
| Component B1) | (parts by weight) | 10.2 |
| Component B2) | (parts by weight) | 9.4 |
| Component C1) | (parts by weight) | 1.7 |
| Component C2) | (parts by weight) | 1.7 |
| Component D1) | (parts by weight) | 0.4 |

TABLE 2
Composition of foams

| | | | Example | | | |
|---|---|---|---|---|---|---|
| | | V1 | 1 | 2 | 3 | 4 |
| Masterbatch 1 | (parts by weight) | 0 | 25 | 50 | 75 | 100 |
| PS 158K | (parts by weight) | 100 | 75 | 50 | 25 | 0 |
| Talkum IT Extra | (parts by weight) | 0.4 | 0.3 | 0.2 | 0.1 | 0 |
| CO₂ | (parts by weight) | 3.5 | 3.5 | 3.5 | 3.5 | 3.5 |
| Ethanol | (parts by weight) | 2.5 | 2.5 | 2.5 | 2.5 | 2.5 |

TABLE 3
compression properties of foams

| | | | | | | | | Closed-cell |
|---|---|---|---|---|---|---|---|---|
| | Density | E-modulus* | Rp2 %** | Rp5 %** | Rp10 %** | Rp50 %** | Rp75 %** | content*** |
| Example | (g/l) | (MPa) | (MPa) | (MPa) | (MPa) | (MPa) | (MPa) | (—) |
| V1 | 45 | 20.7 | 0.38 | 0.69 | 0.73 | 0.72 | 1.20 | >95 |
| 1 | 43 | 6.8 | 0.19 | 0.29 | 0.32 | 0.49 | 0.83 | >95 |
| 2 | 42 | 5.2 | 0.15 | 0.20 | 0.22 | 0.43 | 0.63 | >90 |
| 3 | 45 | 2.5 | 0.10 | 0.15 | 0.17 | 0.29 | 0.55 | >85 |
| 4 | 43 | 1.9 | 0.10 | 0.13 | 0.16 | 0.30 | 0.54 | >85 |

*compressive E-modulus to ISO 381
**compressive strengths at different compressions to DIN 3386-1
***closed-cell content to DIN ISO

It transpires that even small additions of masterbatch 1 engender a distinct improvement in damping characteristics. The increase in compressive strength between 10 and 50% compression with blends from 25 parts by weight of masterbatch is distinctly more pronounced than in the case of purely PS, which shows virtually no increase (inelastic deformation of purely PS foam).

TABLE 4
Flexural properties of foams

| | | Flexibility under |
|---|---|---|
| | Density | bending stress**** |
| Example | (g/l) | (—) |
| V1 | 45 | − |
| 1 | 43 | o |
| 2 | 42 | + |
| 3 | 45 | + |
| 4 | 43 | ++ |

****qualitative assessment of flexibility (‘++’ = very good, ‘+’ = good, ‘o’ = moderate, ‘−’ = low, ‘−−’ = very low)

TABLE 5
Chemical resistance of foams

| | Density | Resistance to | Resistance to |
|---|---|---|---|
| Example | (g/l) | hexane***** | ethyl acetate***** |
| V1 | 45 | − | − |
| 1 | 43 | o | − |
| 2 | 42 | + | o |
| 3 | 45 | + | + |
| 4 | 43 | ++ | ++ |

*****assessment of chemical resistance (‘++’ = very good—does not dissolve in 24 h, ‘+’ = good—partly dissolves within 24 h, ‘o’ = moderate—dissolves within 1 h, ‘−’ = low—dissolves within 10 min, ‘−−’ = very low—dissolves at once)

### V2) Processing Various Masterbatches with and without Addition of further PS

In process variant V2, a masterbatch was initially produced and subsequently foamed up on the tandem foam extrusion rig. The composition of the material is reported in table 6. The composition is reported in parts by weight such that all the polymers sum to 100 parts by weight, and the blowing agents and the nucleating agent (component D1) are additive thereto. In all cases, 3.5 parts by weight of CO₂ and 2.5 parts by weight of ethanol were used for the foam processing (table 7).

TABLE 6
Composition of masterbatches Nos. 2 to 4

Masterbatch No.

| | | 2 | 3 | 4 |
|---|---|---|---|---|
| Component A1) | (parts by weight) | 76.8 | 77.0 | 84.0 |
| Component B1) | (parts by weight) | 5.0 | 10.2 | 8.2 |
| Component B2) | (parts by weight) | 14.6 | 9.4 | 5.1 |
| Component C1) | (parts by weight) | 1.8 | 1.7 | 1.7 |
| Component C2) | (parts by weight) | 1.8 | 1.7 | 1.0 |
| Component D1) | (parts by weight) | 0.5 | 0.4 | 1.0 |

TABLE 7
Composition of foams

| | | Example | | | |
|---|---|---|---|---|---|
| | | 5 | 6 | 7 | 8 |
| Masterbatch 2 | (parts by weight) | 100 | 50 | | |
| Masterbatch 3 | (parts by weight) | | | 100 | |
| Masterbatch 4 | (parts by weight) | | | | 100 |
| PS 158K | (parts by weight) | | 50 | | |
| C02 | (parts by weight) | 3.5 | 3.5 | 3.5 | 3.5 |
| Ethanol | (parts by weight) | 2.5 | 2.5 | 2.5 | 2.5 |

TABLE 8
Flexural properties of foams

| | | Flexibility under |
|---|---|---|
| | Density | flexural load**** |
| Example | (g/l) | (—) |
| V1 | 45 | ~ |
| 5 | 42 | ++ |
| 6 | 46 | + |
| 7 | 43 | ++ |
| 8 | 45 | ++ |

****qualitative assessment of flexibility (‘++’ = very good, ‘+’ = good, ‘o’ = moderate, ‘−’ = low, ‘−−’ = very low)

TABLE 9
Chemical resistance of foams

| | Density | Resistance to | Resistance to |
|---|---|---|---|
| Example | (g/l) | hexane***** | ethyl acetate***** |
| V1 | 45 | − | − |
| 5 | 42 | ++ | ++ |
| 6 | 46 | + | o |
| 7 | 43 | ++ | ++ |
| 8 | 45 | + | + |

***** assessment of chemical resistance (‘++’ = very good—does not dissolve in 24 h, ‘+’ = good—partly dissolves within 24 h, ‘o’ = moderate—dissolves within 1 h), ‘−’ = low—dissolves within 10 min, ‘−−’ = very low—dissolves at once)

### V3) Producing the Blends on the Extruder in One Step

In process variant V3, all the materials were premixed and added together to the melting extruder, compounded and then directly foamed on the tandem foam extrusion rig. The composition of the material is reported in table 10. The composition is reported in parts by weight such that all the polymers sum to 100 parts by weight, and the blowing agents and the nucleating agent (component D1) are additive thereto. In all cases, 3 parts by weight of CO₂ and 2.5 parts by weight of ethanol were used for the foam processing (table 11).

TABLE 10
Composition of masterbatch No. 5

| | | Masterbatch No. |
|---|---|---|
| | | 5 |
| Component A1) | (parts by weight) | 76.8 |
| Component B1) | (parts by weight) | 5.0 |
| Component B2) | (parts by weight) | 14.6 |
| Component C1) | (parts by weight) | 1.8 |
| Component C2) | (parts by weight) | 1.8 |
| Component D1) | (parts by weight) | 0.5 |

TABLE 11
Composition of foams

| | | Example |
|---|---|---|
| | | B9 |
| Masterbatch 5 | (parts by weight) | 100 |
| PS 158K | (parts by weight) | |
| CO₂ | (parts by weight) | 3.5 |
| Ethanol | (parts by weight) | 2.5 |

TABLE 12
Flexural properties of foams

| | | Flexibility under |
|---|---|---|
| | Density | flexural load**** |
| Example | (g/l) | (—) |
| V1 | 45 | − |
| 9 | 43 | ++ |

****qualitative assessment of flexibility (‘++’ = very good, ‘+’ = good, ‘o’ = moderate, ‘−’ = low, ‘−−’ = very low)

TABLE 13
Chemical resistance of foams

| | Density | Resistance to | Resistance to |
|---|---|---|---|
| Example | (g/l) | hexane***** | ethyl acetate***** |
| V1 | 45 | − | — |
| 9 | 43 | ++ | ++ |

### V4) Further Comparative Examples

In the comparative examples featured in V4, a pentane-containing masterbatch was initially devolatilized and subsequently foamed up on the tandem foam extrusion rig with or without addition of PS. The compositions of the material are reported in table 1. The composition is reported in parts by weight such that all the polymers sum to 100 parts by weight, and the blowing agents and the nucleating agent (component D1) are additive thereto. In all cases, 3.5 parts by weight of CO₂ and 2.5 parts by weight of ethanol were used for the foam processing.

TABLE 14
Composition of devolatilized masterbatches No. 1 and No. 6

| | | Masterbatch | Masterbatch |
|---|---|---|---|
| | | No. 1 | No. 6 |
| Component A1) | (parts by weight) | 77.0 | 80.4 |
| Component B1) | (parts by weight) | 10.2 | 10.2 |
| Component B2) | (parts by weight) | 9.4 | 9.4 |
| Component C1) | (parts by weight) | 1.7 | 0.0 |
| Component C2) | (parts by weight) | 1.7 | 0.0 |
| Component D1) | (parts by weight) | 0.4 | 0.4 |

TABLE 15
Composition of foams

Example

| | | 4, 11, 12 | 10 |
|---|---|---|---|
| Masterbatch 5 | (parts by weight) | 100 | |
| Masterbatch 6 | (parts by weight) | | 100 |
| CO₂ | (parts by weight) | 3.5 | 3.5 |
| Ethanol | (parts by weight) | 2.5 | 2.5 |

TABLE 16
Open-cell content of foams

| | | Melt temperature | Closed-cell |
|---|---|---|---|
| | Density | at die exit | content*** |
| Example | (g/l) | (° C.) | (—) |
| 4 | 43 | 120 | >85 |
| 10 | 43 | 120 | <30 |
| 11 | 42 | 80 | <30 |
| 12 | 45 | 140 | <40 |
| V2 | 44 | 134 | <12 |
| V3 | 39.2 | 119 | <4.8 |

***Closed-cell content to DIN ISO

Comparative examples V2 and V3 are taken from U.S. Pat. No. 6,093,752 and WO 98/58991. It transpires that not only the correct choice of composition of the material but also of the appropriate process parameters is important.

1. A thermoplastic extruded foam sheet having a thickness in the range from 15 mm to 200 mm and cells having an average cell size in the range from 20 to 2000 μm, wherein the cell membranes have a fibrous structure with fiber diameters below 1500 nm.

2. The extruded foam sheet according to claim 1 wherein the foam is formed of a polymer matrix comprising at least two incompatible thermoplastic polymers and at least one polymeric compatibilizer and forming a continuous phase and a disperse phase.

3. The extruded foam sheet according to claim 2 wherein the foam comprises a polymer matrix comprising:
A) from 45% to 97.8% by weight of one or more styrene polymers,
B1) from 1% to 25% by weight of one or more polyolefins having a melting point in the range from 105 to 140° C.,
B2) from 1% to 25% by weight of one or more polyolefins having a melting point below 105° C.,
C1) from 0.1% to 20% by weight of at least one butadiene and/or isoprene-containing styrene block copolymer, and
C2) from 0.1% to 10% by weight of at least one ethylene-, butylene- and/or propylene-containing styrene block copolymer.

4. The extruded foam sheet according to claim 3 wherein the polymer matrix consists of the components A) to C2).

5. The extruded foam sheet according to claim 3 wherein the proportion of component B2) is in the range from 2% to 25% by weight (based on the polymer matrix).

6. The extruded foam sheet according to claim 1 having a density in the range from 20 to 150 g/l.

7. The extruded foam sheet according to claim 1 wherein the cells as measured to DIN ISO 4590 are at least 80% closed.

8. The extruded foam sheet according to claim 2 wherein the average diameter of the disperse phase is in the range from 1 to 1500 nm.

9. A process for producing an extruded foam sheet comprising:
a) heating a mixture of at least two incompatible thermoplastic polymers and one or more polymeric compatibilizers to form a polymer melt having a continuous and disperse phase,
b) impregnating the polymer melt with from 1 to 12 parts by weight (based on the sum total of polymers in the polymer melt) of a physical blowing agent, and
c) extruding the foamable polymer melt into a region of lower pressure to form a sheet of foam by expansion in the range from 50 to 160° C. for the temperature of the polymer melt and above 50 bar for the pressure upstream of the die.

10. The process according to claim 9 wherein a masterbatch is used to produce the polymer mixture.

11. The process according to claim 9 wherein one or more of the polymers used are recyclates.

12. The process according to claim 9 wherein the physical blowing agent (T) consists of
(b1) 100-15% by weight (based on (T)) of CO₂,
(b2) 0-85% by weight (based on T) of one or more co-blowing agents selected from the group consisting of: C₁-C₄ alcohols and C₁-C₄ carbonyl compounds, C₂-C₄ carbonyl compounds and C₃-C₄ ketones and formates, and
(b3) from 0% to 10% by weight of water (all based on T).

13. The process according to claim 12 wherein the blowing agent is a mixture of carbon dioxide and ethanol, carbon dioxide and acetone, carbon dioxide and methyl formate or carbon dioxide, ethanol and acetone.

14. An insulating material, material for structural foam, core material for composite applications, material for energy absorption and/or material for packaging applications comprising an extruded foam sheet according to claim 1.

15. An insulating material, material for structural foam, core material for composite applications, material for energy absorption and/or material for packaging applications comprising an extruded foam sheet according to claim 2.

16. The extruded foam sheet according to claim 2, wherein the continuous phase comprises one or more styrene polymers and the disperse phase comprises one or more polyolefins.

17. The process according to claim 9, wherein extruding is performed at above 120° C. for the temperature of the die lip of the slot die.

18. The process according to claim 12, wherein (b1) is 85-15% by weight (based on (T)) of CO₂.

19. The process according to claim 12, wherein (b1) is 75-15% by weight (based on (T)) of CO₂.

20. The process according to claim 12, wherein (b2) is 15-75% by weight (based on (T)) of the one or more blowing agents.

21. The process according to claim 12, wherein (b2) is 25-75% by weight (based on (T)) of the one or more blowing agents.

22. The process according to claim 12, wherein (b3) is 0 to 5% by weight of water (based on T).

23. The process according to claim 12, wherein (b3) is 0 to 0.2% by weight of water (based on T).
